(19) United States
(12) Patent Application Publication
(10) Pub. No.: US 2017/0219754 A1
(43) Pub. Date: Aug. 3, 2017

(54) WIRE-GRID POLARIZING ELEMENT, MANUFACTURING METHOD THEREOF, AND DISPLAY DEVICE

(71) Applicant: BOE TECHNOLOGY GROUP CO., LTD., Beijing (CN)

(72) Inventors: YUNPING DI, Beijing (CN); Wei Wang, Beijing (CN); Jikai Yao, Beijing (CN); Ming Zhu, Beijing (CN); Xin Gu, Beijing (CN); Zhen Liu, Beijing (CN)

(21) Appl. No.: 15/260,751

(22) Filed: Sep. 9, 2016

(30) Foreign Application Priority Data
Feb. 3, 2016 (CN) 201610076984.0

(51) Int. Cl. G02B 5/30; G02F 1/1335

(52) U.S. Cl. CPC G02B 5/3058; G02F 1/133528; Y10S 977/742; Y10S 977/847; B82Y 20/00

(57) ABSTRACT

A wire-grid polarizing element comprising a base substrate, and a carbon nanotube wire-grid and a metal wire-grid which are disposed on the base substrate, wherein the metal wire-grid and the carbon nanotube wire-grid are laminated in a direction perpendicular to the base substrate, and the carbon nanotube wire-grid comprises a plurality of carbon nanotubes having the same axial direction.

### TECHNICAL FIELD

Embodiments of the present disclosure relate to a wire-grid polarizing element and a manufacturing method thereof as well as a display device.

### BACKGROUND

Thin Film Transistor Liquid Crystal Display (TFT-LCD), which is a flat panel display device, has been increasingly applied in the field of high performance display due to its characteristics such as small volume, low power consumption, free of radiation, and relatively low manufacturing cost.

TFT-LCD is comprised of an array substrate and a color filter substrate with a liquid crystal layer disposed therebetween. Further, a first polarizer is disposed on an upper surface of the color filter substrate and a second polarizer is disposed between the array substrate and a backlight module. In the conventional art, the aforementioned polarizers (the first polarizer and the second polarizer) can be made by polyvinyl alcohol (PVA) thin film. In such a configuration, the polarizer allows one polarization component of natural light to pass through and absorbs another polarization component, which would result in a substantive loss of light and a significant reduction of light efficiency.

To solve the above problem, a wire-grid polarizer made of metal materials is further provided in the conventional art. However, the conventional metal wire-grid polarizer is usually formed by plasma dry-etching metals having a high film thickness. The process involves high degree of difficulty and high consumption of time and power. Moreover, the dry-etching process gas contaminates the metal wire-grid, as a result of which the metal wire-grid is susceptible to corrosion.

### SUMMARY

At least one embodiments of the present disclosure provides a wire-grid polarizing element comprising a base substrate, and a carbon nanotube wire-grid and a metal wire-grid which are disposed on the base substrate, wherein the metal wire-grid and the carbon nanotube wire-grid are laminated in a direction perpendicular to the base substrate, and the carbon nanotube wire-grid comprises a plurality of carbon nanotubes having the same axial direction.

At least one embodiment of the present disclosure further provides a display device comprising wire-grid polarizing element mentioned above.

At least one embodiment of the present disclosure further provides a manufacturing method of wire-grid polarizing element comprising forming a carbon nanotube wire-grid and a metal wire-grid on a base substrate, wherein the carbon nanotube wire-grid and the metal wire-grid are laminated in a direction perpendicular to the base substrate, and the carbon nanotube wire-grid comprises a plurality of carbon nanotubes having the same axial direction.

The wire-grid polarizing element according to the embodiments of the present disclosure comprises the carbon nanotube wire-grid and the metal wire-grid which are disposed in a laminated manner. When such a wire-grid polarizing element is manufactured, a plasma dry-etching process etching metal of high film thickness is eliminated. Thus, difficulty of the manufacturing process is reduced and the process stability and the chemical stability of the wire-grid polarizing element are improved.

### BRIEF DESCRIPTION OF THE DRAWINGS

In order to clearly illustrate the technical solutions of the embodiments of the disclosure, the drawings of the embodiments will be briefly described in the following; it is obvious that the drawings described below are only related to some embodiments of the disclosure and thus are not limitative of the disclosure.

FIG. 1 is an illustrative view of a wire-grid polarizing element according to one embodiment of the present disclosure;

FIG. 2 is an illustrative view of a wire-grid polarizing element according to another embodiment of the present disclosure;

FIG. 3 is a schematic graph of TM transmissivity of lights having different wavelengths incident on the wire-grid polarizing elements having metal wire-grids of different thicknesses according to the embodiments of the present disclosure;

FIG. 4 is a schematic graph of TE transmissivity of lights having different wavelengths incident on the wire-grid polarizing elements having metal wire-grids of different thicknesses according to the embodiments of the present disclosure;

FIG. 5 is a schematic graph of polarization ratio of lights having different wavelengths incident on the wire-grid polarizing elements having metal wire-grids of different thicknesses according to the embodiments of the present disclosure;

FIG. 6 is a schematic graph of TM transmissivity of lights having different wavelengths incident on the wire-grid polarizing elements having carbon nanotube wire-grids of different thicknesses according to the embodiments of the present disclosure;

FIG. 7 is a schematic graph of TE transmissivity of lights having different wavelengths incident on the wire-grid polarizing elements having carbon nanotube wire-grids of different thicknesses according to the embodiments of the present disclosure;

FIG. 8 is a schematic graph of polarization ratio of lights having different wavelengths incident on the wire-grid polarizing elements having carbon nanotube wire-grids of different thicknesses according to the embodiments of the present disclosure;

FIG. 9 to FIG. 13 are illustrative views of manufacturing a wire-grid polarizing element according to one embodiment of the present disclosure; and

FIG. 14 to FIG. 18 are illustrative views of manufacturing a wire-grid polarizing element according to another embodiment of the present disclosure.

### DETAILED DESCRIPTION

In order to make objects, technical details and advantages of the embodiments of the disclosure apparent, the technical solutions of the embodiment will be described in a clearly and fully understandable way in connection with the drawings related to the embodiments of the disclosure. It is obvious that the described embodiments are just a part but not all of the embodiments of the disclosure. Based on the described embodiments herein, those skilled in the art can obtain other embodiment(s), without any inventive work, which should be within the scope of the disclosure.

At least one embodiment of the present disclosure provides a wire-grid polarizing element comprising a base substrate, a carbon nanotube wire-grid disposed on the base substrate and a metal wire-grid laminated with the carbon nanotube wire-grid, and the carbon nanotube wire-grid comprises a plurality of carbon nanotubes having the same axial direction.

The wire-grid polarizing element according to the embodiments of the present disclosure comprises the carbon nanotube wire-grid and the metal wire-grid which are disposed in a laminated manner. When such a wire-grid polarizing element is manufactured, a plasma dry-etching process etching metal of high film thickness is eliminated. Thus, difficulty of the manufacturing process is reduced and the process stability and the chemical stability of the wire-grid polarizing element are improved.

In one embodiment of the present disclosure, the carbon nanotube wire-grid is made of carbon nanotube thin film material highly oriented in the same direction, for example is made of super-aligned carbon nanotube thin film material. Since the carbon nanotube (CNT) has a single orientation along the drawing direction in the super-aligned thin film, and a diameter of the carbon nanotube is only about 10 nm, movement of electrons is confined in the axial direction of the carbon nanotube, as a result of which the carbon nanotube will inevitably exhibit polarization property in light absorbing and light reflecting behaviors. If the polarization direction of incident photons is consistent with the axial direction of the carbon nanotube, electrons will move along the axial direction of the carbon tube by the action of the electric field of the photons and the energy of the photons will be transmitted to the electrons, energy of which will be used up in the thermal movement of crystal lattice through scattering by the crystal lattice. In this case, the photons are completely absorbed by the carbon nanotube. If the polarization direction of incident photons is perpendicular to the axial direction of the carbon nanotube, due to the confinement effect of the carbon nanotube, the electrons cannot follow the light field movement of the photons. Thus, the photons will smoothly pass through the carbon nanotube thin film without being absorbed by the carbon nanotube. Therefore, the carbon nanotube thin film can be directly used as an optical polarizer. Further, since the carbon nanotube has an absorption capacity of broad spectrum, the polarizing element made by the carbon nanotube can be operated in a very wide range of wavelength from deep ultraviolet to far infrared and have a good polarizing function in an environment with high temperature and high humidity.

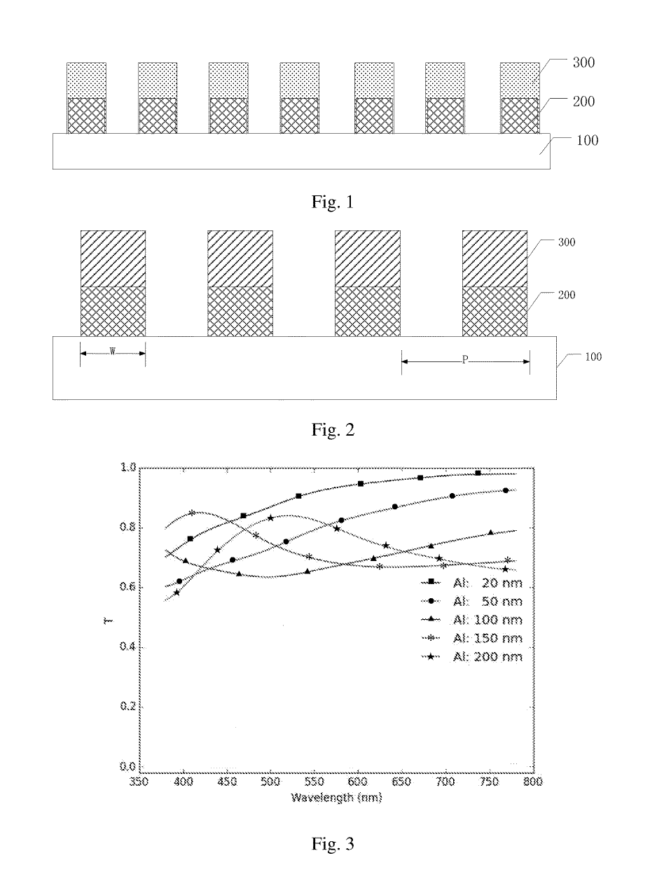

Referring to FIG. 1, which is an illustrative view of a wire-grid polarizing element according to one embodiment of the present disclosure, the wire-grid polarizing element comprises a base substrate 100, a plurality of carbon nanotube wire-grids 200 disposed on an upper surface of the base substrate 100, and a plurality of metal wire-grids 300 laminated with the plurality of carbon nanotube wire-grids and having the same extending direction as that of the carbon nanotube wire-grids 200. The carbon nanotube wire-grids 200 comprises a plurality of carbon nanotubes having the same axial direction. The axial direction of the carbon nanotube (i.e., the extending direction of the carbon nanotube) is consistent with the extending direction of the metal wire-grids 300.

In one embodiment of the present disclosure, material for the carbon nanotube wire-grids comprises materials of carbon nanotube films highly oriented in the same direction. For example, the carbon nanotube films highly oriented in the same direction comprises super-aligned carbon nanotube films.

In one embodiment of the present disclosure, the metal wire-grids 300 can be made of at least one of the following materials: aluminum, argentine, aurum, copper, and tungsten. For example, the metal wire-grids 300 can be made of aluminum.

In one embodiment of the present disclosure, the carbon nanotube wire-grids 200 can have a thickness ranging from 50 nm to 300 nm, for example, a thickness of 100 nm, 200 nm, 250 nm and the like. The metal wire-grids 300 can have a thickness ranging from 50 nm to 200 nm, for example, a thickness of 100 nm, 150 nm and the like.

The wire-grid polarizing element according to the embodiments of the present disclosure utilizes a composite structure of carbon nanotube wire-grids and metal wire-grids. The carbon nanotube wire-grids can be formed by highly oriented carbon nanotube films. By use of anisotropic conductivity of the highly oriented carbon nanotube films and plasmon polariton property of surface-active electrons, carbon nanotube is couplingly resonated with plasmon polariton of surface electrons of the metal wire-grids, which further enhance the transmitted polarized light.

FIG. 2 is an illustrative structural view of a wire-grid polarizing element according to another embodiment of the present disclosure. The wire-grid polarizing element comprises a base substrate 100 provided with a plurality of wire-grids, each of which comprises a carbon nanotube wire-grid 200 and a metal wire-grid 300. The metal wire-grid 300 is made of aluminum (Al). The carbon nanotube wire-grid 200 and the metal wire-grid 300 are laminated on the surface of the base substrate 100. The width W of the wire-grid is 50 nm, and grating period P is 100 nm. Thus, duty cycle W/P is 0.5.

By using light having a wavelength range of 380 nm-780 nm, transmissivity of TM polarized light (the direction of electric field being in parallel with incident plane), transmissivity of TE polarized light (the direction of electric field being perpendicular to incident plane) and polarization ratio of the above-described wire-grid polarizing element are measured under different grating depths (a sum of the thickness d1 of the carbon nanotube wire-grid and the thickness d2 of the metal wire-grid).

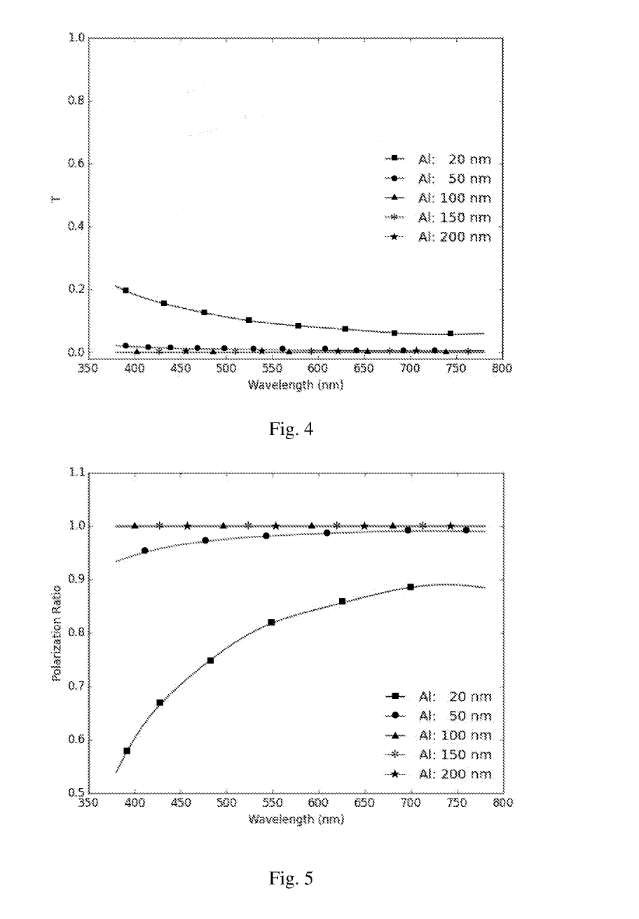

For example, in case that d1 has a constant value of 100 nm, when d2 has a value of 20 nm, 50 nm, 100 nm, 150 nm, 200 nm respectively, the transmissivity of TM polarized light is illustrated in FIG. 3 in which the transmissivity of TM polarized light can reach a range of 70%-80%, the transmissivity of TE polarized light is illustrated in FIG. 4, and the polarization ratio is illustrated in FIG. 5. When d2 has a value of 100 nm, 150 nm, 200 nm, the polarization ratio can reach 0.99.

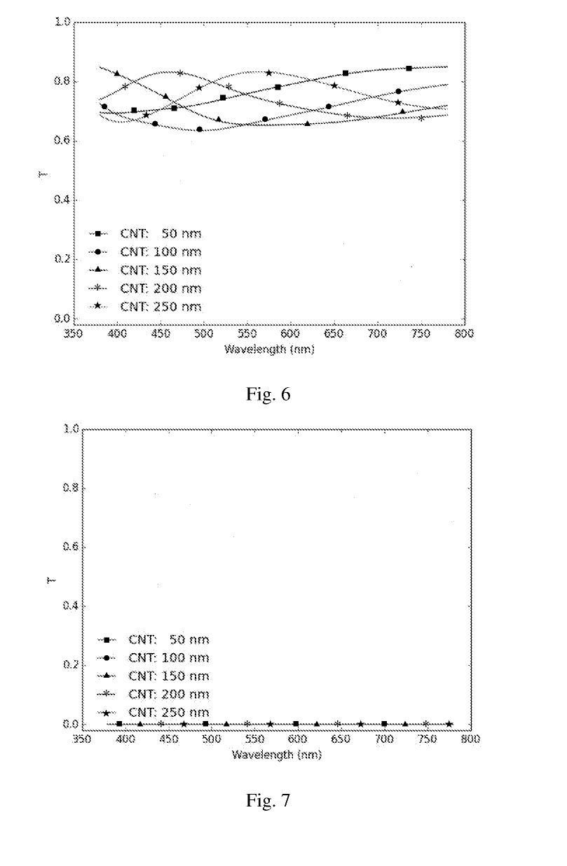

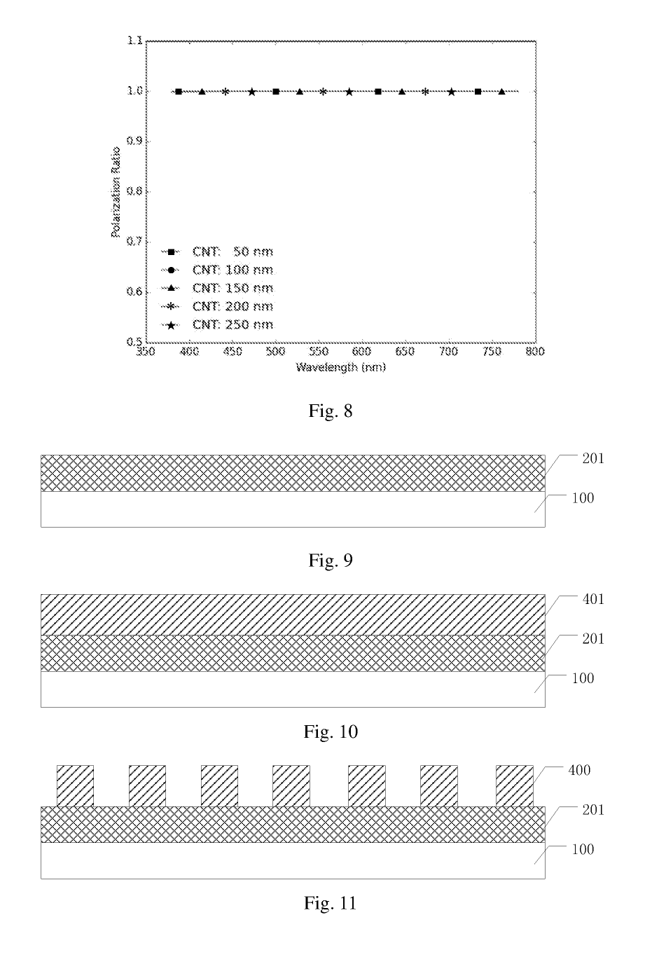

For example, in case that d2 has a constant value of 100 nm, when d1 has a value of 50 nm, 100 nm, 150 nm, 200 nm, 250 nm respectively, the transmissivity of TM polarized light is illustrated in FIG. 6 in which the transmissivity of TM polarized light can reach a range of 70%-80%, the transmissivity of TE polarized light is illustrated in FIG. 7, and the polarization ratio is illustrated in FIG. 8 in which the polarization ratio can reach 0.99. Further, at least one embodiment of the present disclosure provides a display device comprising the above-described wire-grid polarizing element. The display device according to the embodiments of the present disclosure can be any product or component having display function such as display screen of laptop computer, liquid crystal display, liquid crystal television, digital photo frame, cell phone, tablet computer and the like.

At least one embodiment of the present disclosure further provides a manufacturing method of wire-grid polarizing element, comprising forming on a base substrate a carbon nanotube wire-grid and a metal wire-grid arranged in a laminated manner, the carbon nanotube wire-grid comprising a plurality of carbon nanotubes having the same axial direction.

For example, forming on a base substrate a carbon nanotube wire-grid and a metal wire-grid comprises:

forming a carbon nanotube wire-grid on the base substrate; and

forming a metal wire-grid on the carbon nanotube wire-grid.

In one embodiment of the present disclosure, forming a carbon nanotube wire-grid on the base substrate comprises:

forming a carbon nanotube thin film on the base substrate; and

patterning the carbon nanotube thin film so as to form the carbon nanotube wire-grid.

For example, the carbon nanotube wire-grid can be manufactured by use of electron beam photoresist. The manufacturing method of wire-grid polarizing element comprises:

Referring to FIG. 9, firstly, a carbon nanotube thin film 201 is formed on a base substrate (can be a glass substrate) 100. The carbon nanotube thin film 201 can comprise carbon nanotube film highly oriented in the same direction. At first, pretreatment can be performed on the surface of the base substrate 100 and then a carbon nanotube film highly oriented in the same direction is formed thereon by use of arrangement and transfer on liquid surface technology. The thickness of the carbon nanotube film is adjusted by multiple transfer processes, thereby obtaining a carbon nanotube thin film with a desired thickness.

For example, the carbon nanotube thin film 201 can be formed from super-aligned carbon nanotube film by a film drawing process. Since the film thickness of a single layer is usually of several tens of nanometers, the carbon nanotube thin film with a desired thickness can be obtained by multiple film drawing processes.

Next, referring to FIG. 10, electron beam photoresist 401 is coated on the carbon nanotube thin film 201.

And then, referring to FIG. 11, the electron beam photoresist 401 is exposed to light and is developed, thereby forming a pattern of photoresist pattern 400, in which a portion of electron beam photoresist is removed so that a portion of the carbon nanotube thin film 201 is exposed.

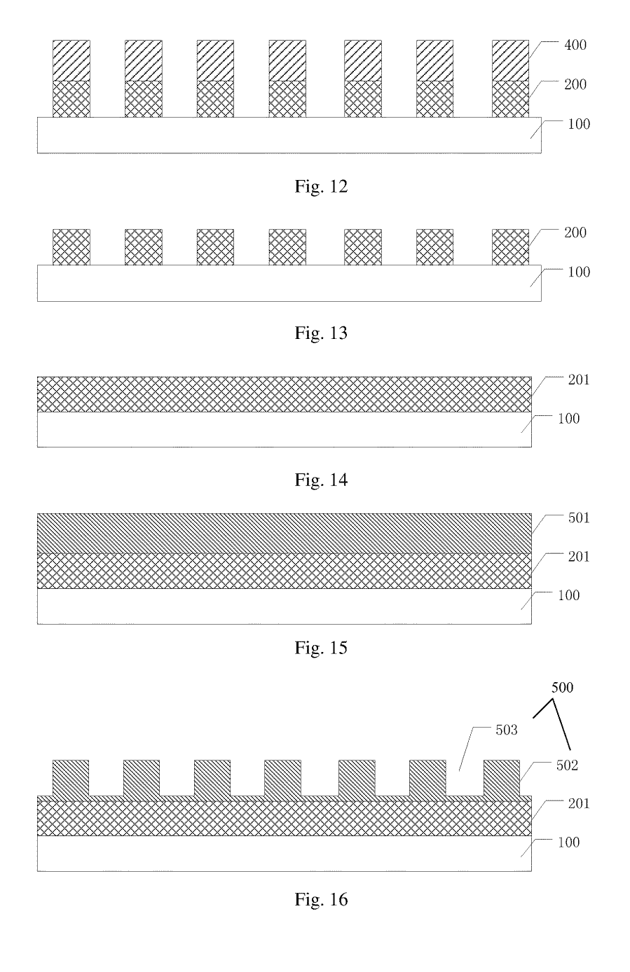

After that, referring to FIG. 12, the exposed portion of the carbon nanotube thin film is removed by an etching process.

Next, the remaining electron beam photoresist is removed and a carbon nanotube wire-grid 200 is formed on the base substrate, as illustrated in FIG. 13.

Finally, a metal wire-grid is formed on the carbon nanotube wire-grid 200 so as to obtain the wire-grid polarizing element as required. For example, the metal wire-grid can be formed by forming a metal film coating the carbon nanotube wire-grid 200 through thermal evaporating deposition process or magnetron sputtering process, and thus a wire-grid polarizing element composited by a carbon nanotube wire-grid and a metal wire-grid is obtained. The structure is thus formed as illustrated in FIG. 1. In the above-described manufacturing process, as the base substrate 100 has already been formed with a carbon nanotube wire-grid, the deposited or sputtered metal material is formed on the carbon nanotube wire-grid as a priority, while there is a few metal material or even no metal material formed between the two adjacent carbon nanotube wire-grids (i.e., the regions on the base substrate where no carbon nanotube wire-grid is disposed) in the deposition process or the sputtering process, since there is a relatively small spacing (smaller than 100 nm) between two adjacent carbon nanotube wire-grids, so that the thus-formed metal film has a much greater thickness on the carbon nanotube wire-grid than that between the two adjacent carbon nanotube wire-grids. Thus, the metal wire-grid can be formed on the carbon nanotube wire-grid without etching the deposited or sputtered metal film.

Further, the carbon nanotube wire-grid can be manufactured by use of nanoimprint photoresist. The manufacturing method of wire-grid polarizing element will be described as follows.

Referring to FIG. 14, firstly, a carbon nanotube thin film 201 is formed on a base substrate 100.

Material for the carbon nanotube thin film 201 can comprise carbon nanotube film highly oriented in the same direction. For example, at first, pretreatment can be performed on the surface of the base substrate 100 and then a carbon nanotube film highly oriented in the same direction is formed thereon by use of arrangement and transfer on liquid surface technology. The thickness of the carbon nanotube film is adjusted by multiple transfer processes, thereby obtaining the carbon nanotube thin film with a desired thickness.

For example, the carbon nanotube thin film 201 can be formed from super-aligned carbon nanotube film by film drawing process. Since the film thickness of a single layer is usually of several tens of nanometers, the carbon nanotube thin film of a desired thickness can be obtained by multiple film drawing processes.

Referring to FIG. 15, a nanoimprint photoresist 501 is coated on the carbon nanotube thin film 201.

Referring to FIG. 16, the photoresist is imprinted by use of nanoimprint die plate and at the same time is cured by UV light, so that a photoresist pattern 500 is formed. The photoresist pattern comprises a convex region 502 and a concave region 503.

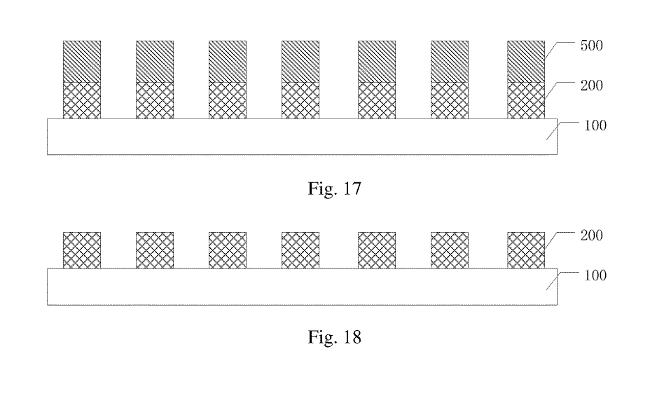

Referring to FIG. 17, the nanoimprint photoresist remained in the concave region 503 and a portion of the carbon nanotube thin film located in the concave region 503 are removed by an etching process. For example, the nanoimprint photoresist remained in the concave region 503 and the portion of the carbon nanotube thin film located in the concave region 503 can be dry-etched by an inductive coupling plasma dry-etching apparatus in one etching.

The remaining nanoimprint photoresist is removed and a carbon nanotube wire-grid 200 is formed on the base substrate as illustrated in FIG. 18.

A metal wire-grid is formed on the carbon nanotube wire-grid 200, thereby obtaining the wire-grid polarizing element as required. For example, the metal wire-grid can be formed by forming a metal film coating the carbon nanotube wire-grid 200 by thermal evaporating deposition process or magnetron sputtering process, and thus a wire-grid polarizing element composited by a carbon nanotube wire-grid and a metal wire-grid is obtained. In the above-described manufacturing process, as the base substrate 100 has already been formed with a carbon nanotube wire-grid, in the deposition process or the sputtering process, the deposited or sputtered metal material is formed on the carbon nanotube wire-grid as a priority (i.e., the regions on the base substrate where no carbon nanotube wire-grid is disposed), while there is a few metal material or even no metal material formed between the two adjacent carbon nanotube wire-grids, since there is a relatively small spacing (smaller than 100 nm) between two adjacent carbon nanotube wire-grids, so that the thus-formed metal film has a much greater thickness on the carbon nanotube wire-grid than that between the two adjacent carbon nanotube wire-grids. Thus, the metal wire-grid can be formed on the carbon nanotube wire-grid without etching the deposited or sputtered metal film.

By forming a carbon nanotube wire-grid made of highly oriented carbon nanotube film on the base substrate in advance and then forming a metal wire-grid by depositing a metal film coating the carbon nanotube wire-grid, the manufacturing method of wire-grid polarizing element according to the embodiments of the present invention avoids performing plasma dry-etching process on metal film of high film thickness. Since the carbon nanotube film is resistant to acid and alkali as well as to temperature and humidity, the wire-grid polarizing element can also have an improved chemical stability.

The foregoing are merely exemplary embodiments of the disclosure, but are not used to limit the protection scope of the disclosure. The protection scope of the disclosure shall be defined by the attached claims.

The present disclosure claims priority of Chinese Patent Application No. 201610076984.0 filed on Feb. 3, 2016, the disclosure of which is hereby entirely incorporated by reference as a part of the present disclosure.

1. A wire-grid polarizing element comprising a base substrate, and a carbon nanotube wire-grid and a metal wire-grid which are disposed on the base substrate, wherein the metal wire-grid and the carbon nanotube wire-grid are laminated in a direction perpendicular to the base substrate, and the carbon nanotube wire-grid comprises a plurality of carbon nanotubes having the same axial direction.

2. The wire-grid polarizing element according to claim 1, wherein the carbon nanotube wire-grid and the metal wire-grid are successively disposed at the same side of the base substrate.

3. The wire-grid polarizing element according to claim 1, wherein the carbon nanotube wire-grid has a thickness of 50 nm to 300 nm, and the metal wire-grid has a thickness of 50 nm to 200 nm.

4. The wire-grid polarizing element according to claim 1, wherein the axial direction of the plurality of carbon nanotubes are consistent with an extending direction of the metal wire-grid.

5. The wire-grid polarizing element according to claim 1, wherein the carbon nanotube wire-grid is made of material comprising carbon nanotube film highly oriented in the same direction.

6. The wire-grid polarizing element according to claim 5, wherein the carbon nanotube film highly oriented in the same direction comprises super-aligned carbon nanotube film.

7. The wire-grid polarizing element according to claim 1, wherein the metal wire-grid is made of at least one of aluminum, argentine, aurum, copper, and tungsten.

8. A display device comprising the wire-grid polarizing element according to claim 1.

9. A manufacturing method of wire-grid polarizing element comprising forming a carbon nanotube wire-grid and a metal wire-grid on a base substrate, wherein the carbon nanotube wire-grid and the metal wire-grid are laminated in a direction perpendicular to the base substrate, and the carbon nanotube wire-grid comprises a plurality of carbon nanotubes having the same axial direction.

10. The manufacturing method of wire-grid polarizing element according to claim 9, wherein forming a carbon nanotube wire-grid and a metal wire-grid on a base substrate comprises:
forming the carbon nanotube wire-grid on the base substrate;
forming the metal wire-grid on the carbon nanotube wire-grid.

11. The manufacturing method of wire-grid polarizing element according to claim 10, wherein forming the carbon nanotube wire-grid on the base substrate comprises:
forming carbon nanotube thin film on the base substrate;
performing a patterning process on the carbon nanotube thin film and forming the carbon nanotube wire-grid.

12. The manufacturing method of wire-grid polarizing element according to claim 11, wherein performing a patterning process on the carbon nanotube thin film comprises:
coating the carbon nanotube thin film with electron beam photoresist;
exposing and developing the electron beam photoresist and forming a photoresist pattern which comprises a photoresist remaining region and a photoresist removed region;
removing a portion of the carbon nanotube thin film in the photoresist removed region through an etching process; and
removing the remaining electron beam photoresist and forming the carbon nanotube wire-grid.

13. The manufacturing method of wire-grid polarizing element according to claim 11, wherein performing a patterning process on the carbon nanotube thin film comprises:
coating the carbon nanotube thin film with nanoimprint photoresist;
curing the nanoimprint photoresist by UV light while imprinting the nanoimprint photoresist and thus forming a photoresist pattern which comprises a convex region and a concave region;
removing a portion of the carbon nanotube thin film in the concave region through an etching process; and
removing the remaining nanoimprint photoresist and forming the carbon nanotube wire-grid.

14. The manufacturing method of wire-grid polarizing element according to claim 11, wherein the carbon nanotube thin film is made of material comprising carbon nanotube film highly oriented in the same direction.

15. The manufacturing method of wire-grid polarizing element according to claim 14, wherein the carbon nanotube film highly oriented in the same direction comprises super-aligned carbon nanotube film.

16. The manufacturing method of wire-grid polarizing element according to claim 11, wherein the carbon nanotube thin film is formed through arrangement and transfer on liquid surface technology.

17. The manufacturing method of wire-grid polarizing element according to claim 16, wherein thickness of the carbon nanotube film is adjusted by multiple transfer processes.

18. The manufacturing method of wire-grid polarizing element according to claim 11, wherein the carbon nanotube thin film is formed from super-aligned carbon nanotube film through a film drawing process.

19. The manufacturing method of wire-grid polarizing element according to claim 18, wherein thickness of the carbon nanotube film is adjusted by multiple film drawing processes.

20. The manufacturing method of wire-grid polarizing element according to claim 9, wherein the metal wire-grid is formed through a thermal evaporating deposition process or a magnetron sputtering process.
